(19) United States
(12) Patent Application Publication
(10) Pub. No.: US 2002/0058239 A1
(43) Pub. Date: May 16, 2002

(54) Teaching and entertaining apparatus

(76) Inventor: Chi-Hsiang Wang, Taipei (TW)

Correspondence Address: FRANCIS EDWARD MARINO, 394 MEREDITH NECK ROAD, MEREDITH, NH, 03253, US

(21) Appl. No.: 09/969,080

(22) Filed: Oct. 2, 2001

Related U.S. Application Data
(60) Provisional application No. 60/237,492, filed on Oct. 4, 2000.
(60) Provisional application No. 60/282,297, filed on Apr. 9, 2001.

(51) Int. Cl. G09B 23/28

(52) U.S. Cl. 434/263

(57) ABSTRACT

An electronic device that assists, teaches, and inspires a user to perform otherwise unfamiliar or difficult tasks, during the time that the user is actually performing the task. In a preferred embodiment, the device comprises a visual and audible program for leading the user sequentially through the proper steps of the activity. The device is alternately embodied as a toothbrush holder having a timing or teaching function incorporated therein.

### FIELD OF THE INVENTION

The present invention is related to devices for inspiring and assisting persons during toothbrushing and other such activities. More specifically, it is a device of guiding and entertaining persons during otherwise mundane or unlearned activities such as toothbrushing and for ensuring that they perform the activity properly and for the recommended period of time. As disclosed herein, it can be embodied as a visual and audible teaching aid or a toothbrush holding apparatus that includes an audible routine or music-playing electronic circuit. The circuit may play one or more songs for a defined period or may lead the user visually and audibly through the steps of the particular activity.

### BACKGROUND AND OBJECTS OF THE INVENTION

Certain activities are known to be mundane, unfamiliar, or prone to be improperly performed. Activities such as toothbrushing, performing CPR, and cooking, require that the person performing the activity not only perform the activity a certain way, but also require that certain of the steps of the activity last a certain amount of time and follow a certain sequence.

For instance, it has been determined that tooth-brushing is more often than not done improperly. Proper brushing should require at least two minutes, and that time should be properly shared among the teeth, yet most persons do not brush for nearly so long and tend to concentrate their efforts on only the most visible outer surfaces of the teeth. It is found through numerous studies that proper and thorough cleaning of the teeth cannot generally be achieved in less than two minutes and that taking more time generally results in excessive wear to the enamel of the teeth.

When brushing teeth, it is not only important for the brusher to brush each area for a certain length of time, but it is also important to brush the teeth in a certain order and to brush each tooth type in a specific direction. It is often recommended that adult molars be brushed vigorously in a swirling motion for at least five seconds per tooth, while adult bi-cuspids should be brushed lightly in an up-down motion for at least eight seconds per tooth. The recommended regimen for children's teeth is somewhat different. As can be imagined, remembering and properly following such a protocol can be a difficult task, especially for children who have a notoriously shorter attention span than adults.

It is an especially well-recognized problem that children do not brush properly or for the right amount of time, and this is generally blamed on the lack of interest that toothbrushing provides to them. It is found that children are easily bored by toothbrushing and tend to concentrate their brushing on only the few frontmost teeth without some inspiration to do a more thorough job.

Attempts have been made to address the amount of time spent brushing by providing electric toothbrushes that include timers with an alarm. These timers generally start a two-minute period once the toothbrush is energized and sound an alarm “beep” once two minutes have elapsed. But these alarms are deficient for several reasons. First, they do not allow the user to recognize the amount of time that has elapsed at any given moment during the two minute period, and so do not assist the user to properly share the brushing period amongst the teeth. Further, during the two-minute period between the start of the brushing period and sounding of the alarm, no entertainment or instruction is provided. Because two minutes can be a relatively long amount of time, especially to a child, when performing an activity such as toothbrushing and while awaiting the sounding of an alarm (just as with a “watched pot”), this period can be quite boring and can often lull the person into state of inattention that results in improper brushing. As such, these devices can ironically cause the very effect that is opposite to that which was desired in the first place.

Numerous other activities face the same problems as toothbrushing. Activities as obvious to some such as changing a spare tire or installing a wall switch might be totally unfamiliar and therefore dangerous to others. No inexpensive, portable and effective means is available for assisting the inexperienced to perform such activities, nor is any inexpensive and portable means available for audibly and visually teaching the proper performance of numerous such activities over such a wide range of topics.

It is therefore an object of the present invention to provide a device for guiding and teaching persons through the steps and sequences of various activities, such as toothbrushing, by displaying images to demonstrate the steps of the activity and to narrate the procedure for performing the activity, all while timing the activity properly and according to the recommended protocol.

It is an additional object to provide better means for inspiring persons to properly brush their teeth and perform other such activities.

It is an additional object to provide means to entertain persons while they brush their teeth and perform other such activities.

It is an additional object to provide means that combine such inspiration and entertainment.

It is a further object to provide means for teaching persons how to properly brush their teeth while they are brushing or to properly perform other such activities while they are being performed.

It is an additional object to provide means for helping persons brush all of their teeth in a manner that ensures each tooth is brushed properly and for an adequate period of time, or to do the equivalent while performing other such activities.

It is a further object to inspire children to want to brush their teeth or perform other such activities that they typically might attempt to avoid.

Further objects and advantages of the present invention will become apparent upon review of the following disclosure of my invention, which includes a description and drawings to teach the preferred embodiment thereof.

### SUMMARY OF THE INVENTION

The present invention is a device that assists, teaches, and inspires a user to perform otherwise unfamiliar or difficult tasks, during the time that the user is actually performing the task. In one embodiment, it not only inspires a user, such as a young child, to brush his or her teeth by offering some excitement to the tooth-brushing experience and by entertaining the user during the experience, but further inspires the user to continue brushing for a full two minutes and allows the user to know that those two minutes have passed. Other embodiments of the device include timed indicators and instructional aides to lead the user through such activities as leading through the brushing of teeth in various portions of the mouth for various lengths of time, so that a proper attention is devoted to each tooth and so that each tooth is brushed in the appropriate manner.

### DESCRIPTION OF THE DRAWINGS

FIG. 1 is a perspective view of the preferred embodiment of the invention,

FIG. 2 is a circuit diagram of the embodiment of FIG. 1,

FIG. 3 is a perspective view of a second embodiment of the invention with its activity card exploded therefrom,

FIG. 4 is a perspective view of a third embodiment of the invention,

FIG. 5 is a front elevational view of a fourth embodiment of the invention,

FIG. 6 is a left-side elevational view of the embodiment of FIG. 5,

FIG. 7 is a transparent perspective view of the embodiment of FIG. 5, taken from a rightward perspective,

FIG. 8 is a perspective view of the embodiment of FIG. 5, taken from a rearward perspective, and

FIG. 9 is a circuit diagram of the embodiment of FIG. 5.

### DETAILED DESCRIPTION OF THE PREFERRED EMBODIMENT OF THE INVENTION

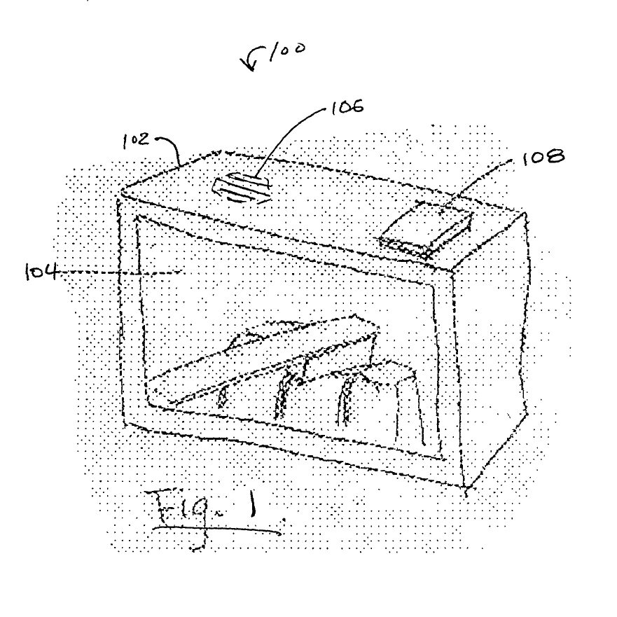

Various embodiments according to the present invention are depicted in the included drawings, with the preferred embodiment being a visual and audible teaching device that is the subject of FIGS. 1 through 3.

The present invention is an electronic device that includes one or more programs each adapted for guiding a user through the steps of an activity. The device includes both a display for showing either still or moving images of the activity and a speaker for giving audible instructions related to the activity.

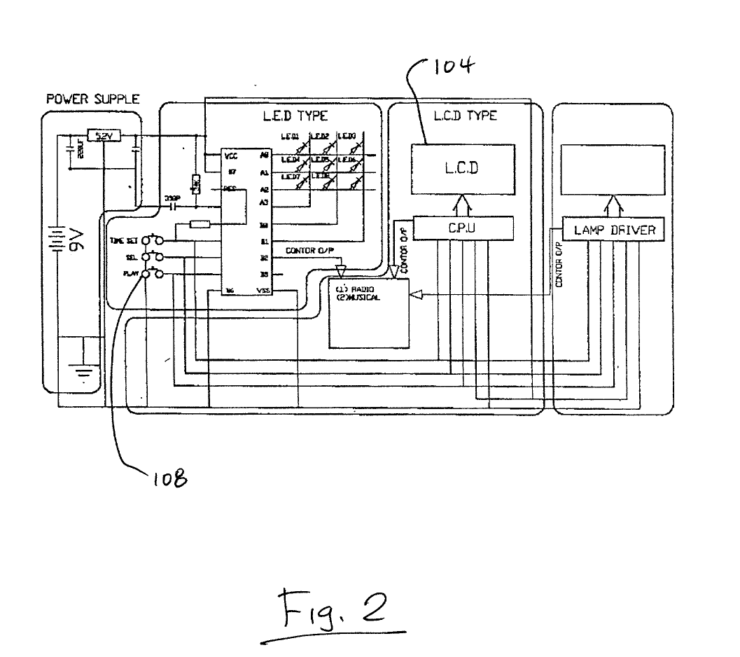

In the preferred embodiment of FIGS. 1 and 2, the device is a small portable module 100 having a housing 102 that includes a display 104 and a speaker 106. The display can be either an LCD array or an LED array of any such type of display. A readonly memory (ROM) within the device stores a program for a particular activity. A “Start” button 108 is provided to begin the playing of the activity program.

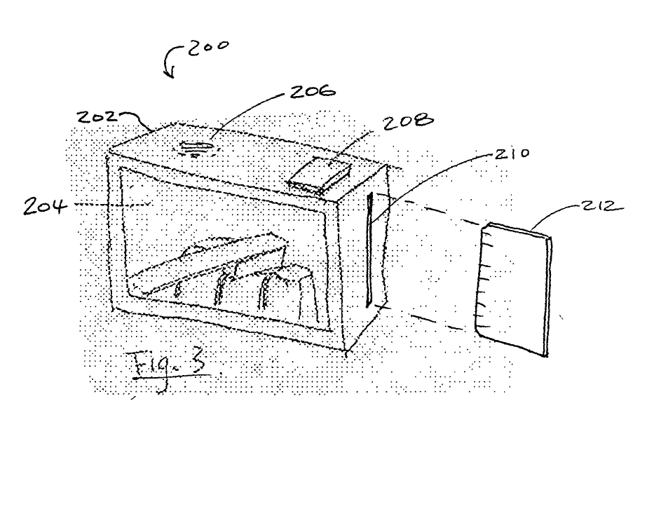

The second embodiment 200 of FIG. 3 is similar to the preferred embodiment except that no internal memory is provided and the housing instead includes a slot 210 for receiving one of many available activity cards 212 which are each preprogrammed with the information for a particular activity, such as toothbrushing, performing CPR, cooking a particular recipe, building a piece of craft work, etc.

The program for the activity leads the user through each step of the activity, while providing specific instructions and graphical images to assist the user in performing the steps. The program is timed and sequenced such that the user will properly time and sequence the activity automatically as he follows the instructions.

For instance, a child following a program for brushing his teeth will see images and hear instructions telling him how much toothpaste to put onto his toothbrush. The moving images will depict toothpaste of the correct quantity being applied to a toothbrush. Comments will be made about not putting more or less toothpaste and the problems that such could cause would be advised. Then the image would switch to the brushing of incisors with the proper up and down stroke and comments would be made about this activity, such as how much pressure to apply, how to position the jaws for proper access to the teeth, etc. These comments would last for say twenty seconds to ensure that the child brushed his incisors for that recommended amount of time. Next, the image would switch to the brushing of the right molars with the proper swirling motion and instructory comments would be made that lasted say twenty seconds. This procedure would be followed for each section of the mouth until the toothbrushing activity had been completed and timed to cause the child to brush for the recommended two minutes. The image would switch to show and instruct the child about properly washing his brush and replacing it in its holder, and even on cleaning up the sink and surrounding area.

The device is equipped with means to be attached to the bathroom mirror so that it is readily available to the child every time he begins to brush his teeth.

It is intended that this procedure and device will not only assist the child to properly brush his teeth, but will also make the activity an enjoyable activity. For instance, the narrative could be spoken by a popular voice to the child. Or throughout the process, a familiar children's tune could be played in the background of the program's narrative. Or the images could be in cartoon format and show a popular cartoon character brushing his teeth. To maintain the child's interest, a plurality of activity cards could be purchased for each activity. For instance, one night the child could brush his teeth with Mickey Mouse, while the next night he could brush his teeth with Donald Duck.

For the device as embodied in FIG. 3, other activity cards to assist the child in performing other activities are also available. For instance, one activity card provides step-by-step instructions and images for tying shoes, and another for making the bed. Over time, the child can collect a myriad of activity cards. As the child matures, he can purchase cards related to more mature subjects.

Another preprogrammed activity card for the device would instruct and demonstrate the various steps for performing Cardio-Pulmonary Resuscitation (CPR). The User would be told each step to perform, and lead to time the steps properly. Such a device could be worn on a string around the neck by persons prone to heart failure, in the same way that medical alert bracelets are worn. In this way, another person finding the wearer unconscious would find the device and see a bold instruction to push a “Start” button that would begin the instructory program and lead through the proper steps to resuscitate the victim.

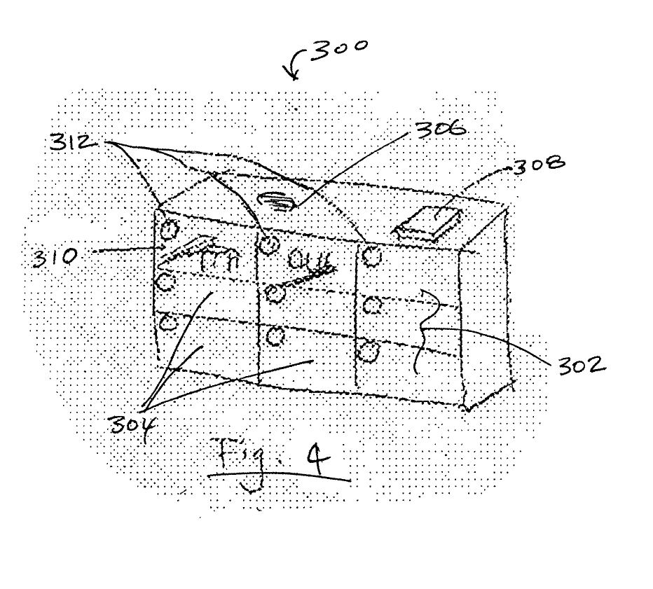

A third embodiment 300 of the device, depicted in FIG. 4, is simpler and less animated than those two embodiments thus described. It comprises a display area 302 divided into a multitude of image segments 304, and a “Start” button 308. Each image segment includes a permanent image 310 and an LED 312. When the “Start” button is triggered, a timer sequences through each segment and lights that segments LED for a predetermined length of time. For instance, in an equivalent to the toothbrushing activity described above, this embodiment would have images of each step in the segments and would light the LED for that step for the recommended time period. During the playthrough of the program, a two-minute long musical tune is played to entertain the user while he is brushing.

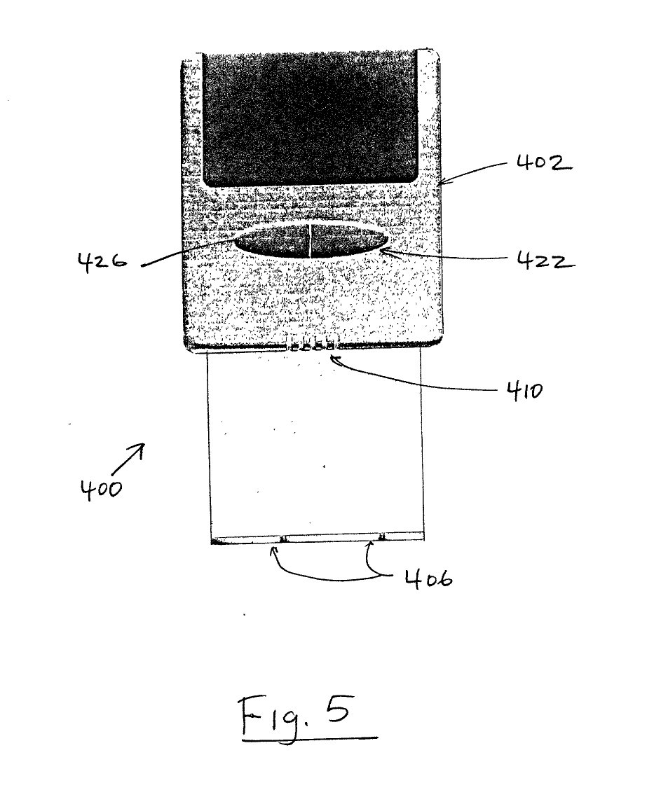

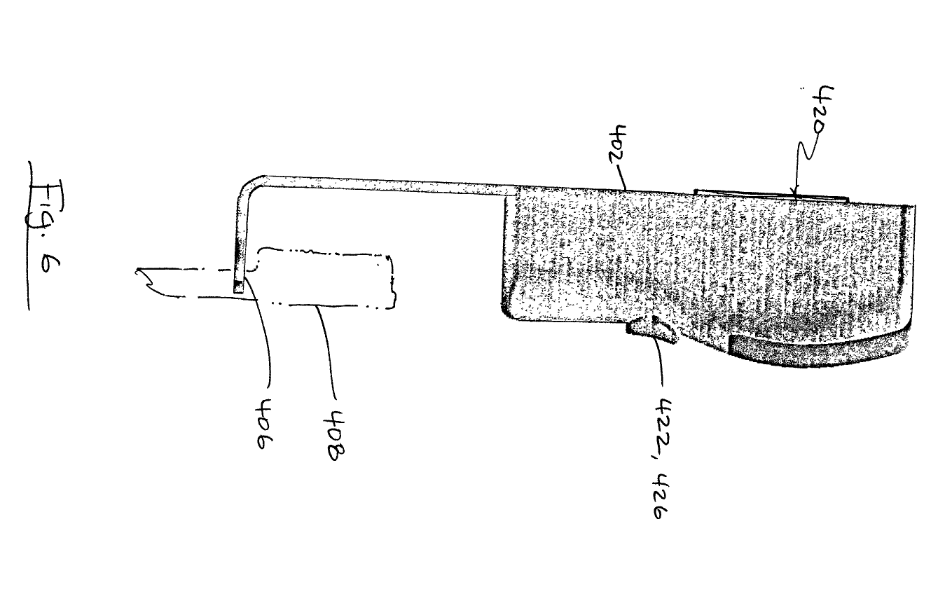

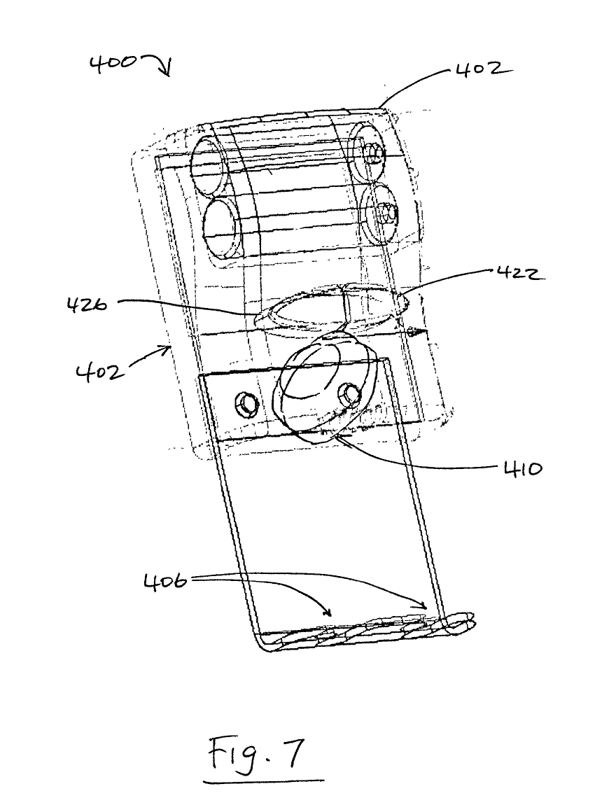

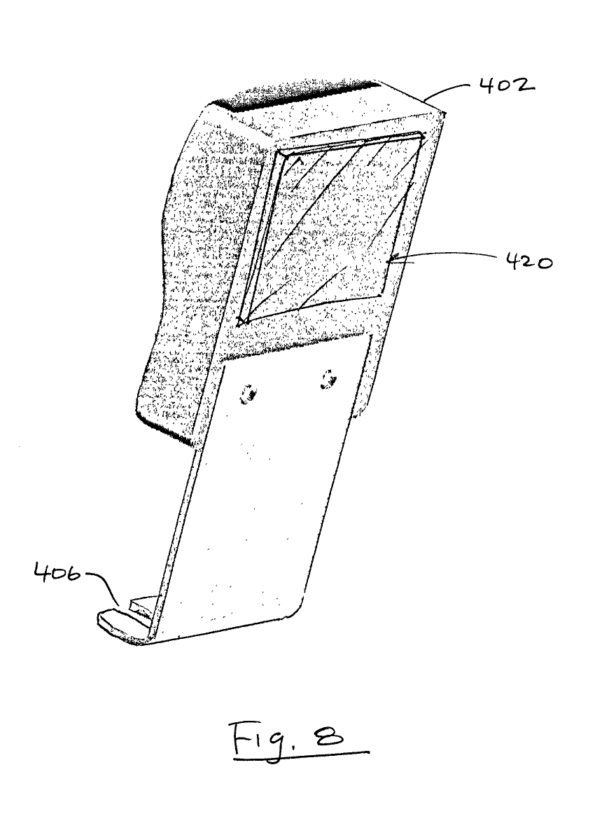

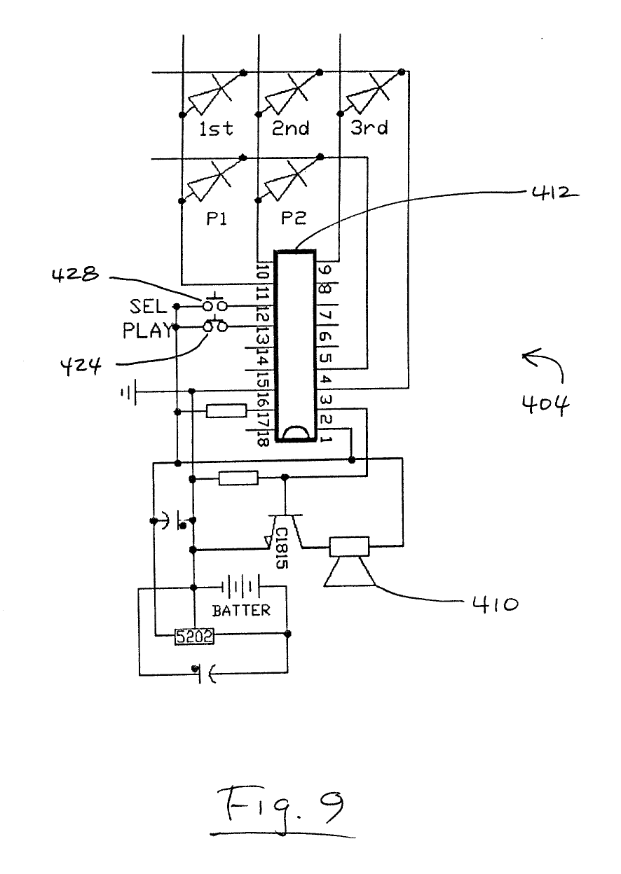

A fourth embodiment of the invention is depicted in FIGS. 5 through 9, which is toothbrush holder 400 comprising a plastic housing 402 for encasing an electronic circuit 404 and a slotted hanger 406 for accepting one or more toothbrushes 408. The circuit, shown in FIG. 9, includes a speaker 410 and a programmable IC 412 that causes a verbal procedure to be recited or music to be played by the speaker. For instance, to persuade a child to brush for a full two minutes, a single song that plays for two minutes or several songs whose length totals two minutes might be played.

The housing 402 includes a “peel & stick” backing tape 420 to allow a user to affix the holder to a wall. Alternatively, the housing could be held to the wall by other means such as screws or glue, or the holder could include a stand for supporting the holder on a countertop or such. It is desirable that the housing be affixed high enough on the wall or that the stand be tall enough to ensure that the toothbrushes can hang freely from the slots and thereby drip dry after use.

The housing also includes a “Start” button 422 that is connected to a push-button switch 424 and a “Select” button 426 that is connected to another push-button switch 428. The IC 412 includes a digital memory that is preprogrammed to include those one or more songs or procedures. The circuit also includes a battery 426. A timer is included in the IC that is activated by pressing the “Start” button to energize the circuit and play the songs through the speaker 410. Alternatively, a song having a total playing time of two minutes could be programmed and the timer could be eliminated. The “Select” button and switch allow the user to select from a number of songs that are programmed into the IC.

Also alternatively, the memory could be programmed with a vocal story that could entertain or instruct the user for two minutes. For instance, the story could lead the user through a brushing protocol that lasts for two minutes and leads the user to follow a brushing procedure designed to ensure that all teeth get brushed for a specified amount of time. The story might be told by a voice belonging to a character well known to users of a targeted age group. In such an alternate embodiment, the housing might also include a representation or shape of that character.

After the user removes his or her toothbrush, the “Select” button is pressed repeatedly until the desired song is selected. Then the “Start” button is pressed to begin the playing cycle. Alternatively, the toothbrush-holding slots could be equipped with a switch to sense the removal of a toothbrush and begin the playing cycle. As the user brushes, the song or story is played. If the song or story is less that than two minutes long, it begins again once completed. At the end of two minutes, it stops. Once the song or story ends, the user knows that the teeth have been properly brushed and can return the brush to the slot. In the embodiment that includes a holding-slot switch, the circuit could easily be adapted to recognize when the toothbrush is returned prematurely and remind the user to continue brushing.

In another anticipated embodiment that is not depicted herein, the housing is shaped like a famous character that has a well-known voice. When the child removes the toothbrush from the holding-slot, a switch at the slot senses the removal and begins an audible program in which the character's voice instructs the child to put toothpaste on his brush, to begin brushing his front teeth, and to “be sure to brush up and down”. Fun phrases like “oops, you missed a spot” and “nice job on that tooth” might be stated to entertain the child. The program will lead the child around his mouth such as from the front to back teeth with special instructions for more important areas. Once the two-minute period is over, the program could instruct the child to rinse his brush clean and return it to the holding-slot and could even keep reminding if it does not sense that the brush has been returned.

It is also anticipated that the circuit could alternatively include a mechanical means for playing the tune or instructions, such as by a mechanical tape player or a mini-disc player. In this way, the user could have a library of programs and could listen to a different routine each time he brushed. Or else the digital memory IC that contains the song program could be easily replaceable by the child to allow him to maintain a library of electrically stored songs.

Other embodiments of the holder are anticipated or considered obvious adaptations of the invention. So long as the key features of holding one or more toothbrushes and playing some entertaining or instructive program are incorporated, a device should be considered to fall within the scope of the invention. It should be noted that the described is simply the embodiment of the invention currently preferred by the inventor and that numerous alternative embodiment might be within the scope of the invention. As such, the rights afforded to the inventor under this patent should only be limited by the following claims.

I claim:

1. An apparatus both for holding at least one toothbrush and for aiding in the act of toothbrushing, said apparatus comprising;
toothbrush holding means, a speaker, an audible program, means for both starting said audible program and playing said audible program through said speaker for approximately two minutes.

2. The apparatus of claim 1 wherein said audible program comprises a song.

3. The apparatus of claim 1 wherein said audible program comprises an instructive narration.

4. The apparatus of claim 3 wherein said instructive narration is a sequential set of instructions for guiding a user through the sequence and timing for proper toothbrushing.

5. The apparatus of claim 1 wherein said audible program is comprised on a removable memory means and said apparatus further comprises means for accepting and releasing said removable memory means such that said audible program may be removed from said apparatus with said removable memory means and may be replaced by another different audible program comprised on another removable memory means.

6. The apparatus of claim 5 wherein said audible program comprises a first song and said another different audible program comprises a second song.

7. The apparatus of claim 5 wherein said audible program comprises a first instructive narration and said another different audible program comprises a second instructive narration.

8. The apparatus of claim 1 wherein said means for both starting and playing said audible program comprises means for sensing removal of a toothbrush from said toothbrush holding means and wherein said audible program is started thereupon.

9. The apparatus of claim 8 wherein said audible program comprises a song.

10. The apparatus of claim 8 wherein said audible program comprises an instructive narration.

11. The apparatus of claim 8 wherein said audible program is comprised on a removable memory means and said apparatus further comprises means for accepting and releasing said removable memory means such that said audible program may be removed from said apparatus with said removable memory means and may be replaced by another different audible program comprised on another removable memory means.

12. The apparatus of claim 11 wherein said audible program comprises a first song and said another different audible program comprises a second song.

13. The apparatus of claim 11 wherein said audible program comprises a first instructive narration and said another different audible program comprises a second instructive narration.

14. An electronic apparatus for providing visual and audible guidance through a multi-step procedure and comprising;
an electronic memory having therein a program according to the multi-step procedure and comprising a set of visual images and a set of sequentially-timed narrative instructions associated therewith,
a display for displaying said visual images, and
a speaker for playing said sequentially-timed narrative instructions.
